(19) United States
(12) Patent Application Publication
(10) Pub. No.: US 2012/0326983 A1
(43) Pub. Date: Dec. 27, 2012

(54) INTEGRATED PROJECTOR

(75) Inventor: YI-HUNG HSIEH, Tu-Cheng (TW)

(73) Assignee: HON HAI PRECISION INDUSTRY CO., LTD., Tu-Cheng (TW)

(21) Appl. No.: 13/193,597

(22) Filed: Jul. 28, 2011

(30) Foreign Application Priority Data
Jun. 23, 2011 (TW) 100121921

(51) Int. Cl. G06F 3/02

(52) U.S. Cl. 345/168

(57) ABSTRACT

An integrated projector is provided. The integrated projector includes a keyboard, a projector, a data processing unit, and a housing. The data processing unit is electrically connected to the projector to provide information to the projector to project. The housing includes a cover and a base. The cover is attached to the base. The keyboard is fixed on the cover. The base defines a first receiving space to receive the host and a second receiving space to receive a projector. A sidewall further defines an open end communicating with the second receiving space. The projector is capable of moving out of or into of the second receiving space through the open end.

### BACKGROUND

1. Technical Field

The present disclosure relates to projectors and, particularly, to an integrated projector.

2. Description of Related Art

Light-weight projectors have been developed that can be coupled to computers to project a computer generated image onto a screen or other surfaces. For example, users may project presentations created and stored in the computer onto a screen or wall. Such projectors are not always accessible to the user thereby limiting the ability to conduct presentations. Additionally, utilizing computer controlled projectors requires interconnecting cables and a general knowledge of computers to connect the light projector to the computer.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of an integrated projector in accordance with an exemplary embodiment.

FIG. 2 is an exposed isometric view of the integrated projector of FIG. 1.

### DETAILED DESCRIPTION

Embodiments of the present disclosure are now described in detail, with reference to the accompanying drawings.

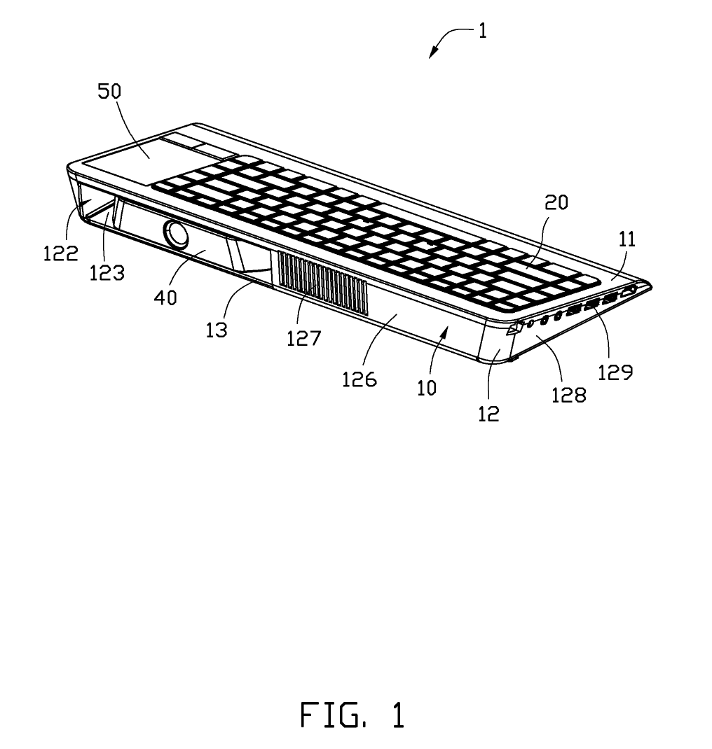

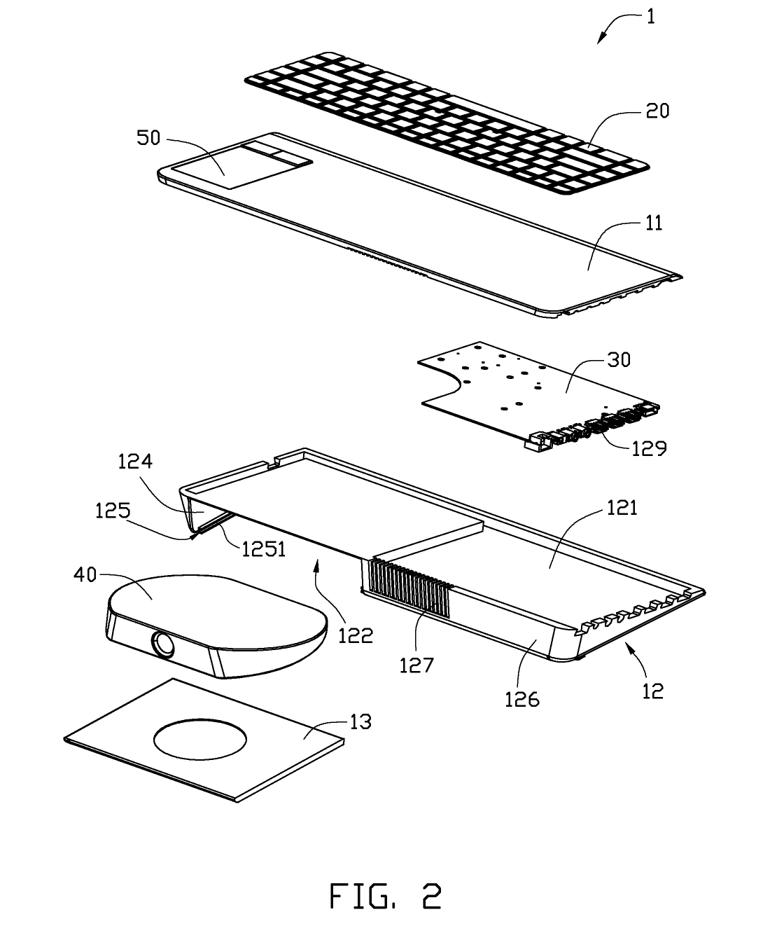

Referring to FIGS. 1-2, an integrated projector 1 includes a housing 10, a keyboard 20, a data processing unit 30, and a projector 40. The integrated projector 1 is used to project information. The keyboard 20 is used to receive a user input. The keyboard 20 is attached to the top of the housing 10. The data processing unit 30 is arranged within the housing 10. The projector 40 is movably arranged in the housing 10. The data processing unit 30 is electrically connected to the projector 40, and provides information for the projector 40 to project information. In the embodiment, the data processing unit 30 is connected to the projector 40 through a cable (not shown).

The housing 10 includes a cover 11 and a base 12. The cover 11 is attached to the base 12. The keyboard 20 is attached to the top of the cover 11. The base 12 defines a first receiving space 121 and a second receiving space 122. The first receiving space 121 and the second receiving space 122 are separated by a plate. The data processing unit 30 is accommodated in the first receiving space 121. The second receiving space 122 further includes an open end 123 defined in a sidewall of the base 12. The open end 123 communicates with the second receiving space 122. The projector 40 is movably received in the second receiving space 122, and capable of moving out of or into the second receiving space 122 through the open end 123.

The integrated projector 1 further includes a touch pad 50 to receive a touch from a user. The touch pad 50 is fixed on the cover 11. In the embodiment, the touch pad 50 is on the right of the keyboard 20.

In the embodiment, the second receiving space 122 includes two opposite sidewalls 124 extending along the width of the second receiving space 122. Each sidewall 124 includes a guiding member 125 protruding inward. The guiding member 125 defines a groove 1251. The housing 11 further includes a base plate 13 whose opposite sides are slidably received in the grooves 1251. In the embodiment, the length of the base plate 13 is the same as the distance between the two guiding members 125. The projector 40 is placed on the base plate 13. When an external force pulls the base plate 13, the projector 40 will move with the base plate 13. After the projector 40 is pulled out of the second receiving space 122, the projector 40 can rotate relative to the base plate 13 when an external force is exerted on the projector 40. Thus, the projection direction of projector 40 can be easily adjusted.

In the embodiment, at least of one sidewall 126 of the first receiving space 121 defines a heat dispersing window 127. In the embodiment, the number of the sidewall 126 defining heat dispersing window 127 is one. The integrated projector 1 further includes a number of ports 129. The ports 129 extend through another sidewall 128 of the first receiving space 121, through which the integrated projector 1 can be connected to an electronic device.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An integrated projector comprising:
a keyboard;
a projector;
a data processing unit electrically connected to the projector and providing information to the projector to project; and
a housing comprising a cover and a base, the cover being attached to the base, the keyboard being mounted on the cover, the base defining a first receiving space to receive the data processing unit, and a second receiving space to receive the projector, a sidewall further defining an open end that communicates with the second receiving space, wherein the projector is capable of moving out of or into the second receiving space through the open end.

2. The integrated projector as described in claim 1, wherein at least one sidewall of the first receiving space further defines a heat dispersing window.

3. The integrated projector as described in claim 1, further comprising a touch pad to receive touch from a user, wherein the touch pad is fixed on the cover.

4. The integrated projector as described in claim 1, further comprising a base plate, wherein opposite sidewalls of the second receiving space respectively comprise a guiding member protruding inward, and each guiding member defining a groove, and opposite edges of the base plate are slidably received in the grooves.

5. The integrated projector as described in claim 1, wherein the length of the base plate is the same as the distance between two guiding members.

6. The integrated projector as described in claim 1 further comprising a plurality of ports to transfer data.
